(19) United States
(12) Patent Application Publication
(10) Pub. No.: US 2023/0294985 A1
(43) Pub. Date: Sep. 21, 2023

(54) Low carbon hydrogen fuel

(71) Applicant: TOPSOE A/S, Kgs. Lyngby (DK)

(72) Inventors: Steffen Spangsberg CHRISTENSEN, Køge (DK); Arunabh SAHAI, Faridabad, Haryana (IN); Kim AASBERG-PETERSEN, Allerød (DK)

(73) Assignee: TOPSOE A/S, Kgs. Lyngby (DK)

(21) Appl. No.: 18/006,628

(22) PCT Filed: Aug. 16, 2021
(86) PCT No.: PCT/EP2021/072731

§ 371 Date: Jan. 24, 2023

(30) Foreign Application Priority Data
Aug. 17, 2020 (IN) 202011035430
Oct. 8, 2020 (DK) PA 2020 01155

(51) Int. Cl. C01B 3/48; B01J 19/24; B01J 19/00; C01B 3/52; B01D 53/14; B01D 53/18

(52) U.S. Cl. CPC C01B 3/48; B01J 19/245; B01J 19/0013; C01B 3/52; B01D 53/1475; B01D 53/1418; B01D 53/18; B01J 2219/00157; C01B 2203/0244; C01B 2203/0283; C01B 2203/0415; C01B 2203/042; C01B 2203/0405; C01B 2203/046; C01B 2203/0475; C01B 2203/0822; B01D 2257/504; B01D 2256/16; B01D 2252/204

(57) ABSTRACT

A plant and process for producing a hydrogen rich gas are provided, said process comprising the steps of: reforming a hydrocarbon feed in an autothermal reformer thereby obtaining a syngas; shifting said syngas in a shift configuration including a high temperature shift step; removal of CO₂ in a CO₂-removal section by amine wash thereby forming a hydrogen rich stream, a portion of which is used as low carbon hydrogen fuel, as well as a CO₂-rich gas and a high-pressure flash gas stream. The high-pressure flash gas stream is advantageously integrated into the plant and process for further improving carbon capture.

### FIELD OF THE INVENTION

The present invention relates to the decarbonization of hydrocarbon gases such as natural gas. In particular, the present invention relates to a plant and process for the production of hydrogen from a hydrocarbon feed, the plant and process comprising one or more fired heaters for preheating the hydrocarbon feed, reforming, shift conversion and CO₂-removal. In particular, the present invention concerns a plant and process for producing hydrogen from a hydrocarbon feed, in which the hydrocarbon feed is subjected to reforming in an optional pre-reformer and an autothermal reformer (ATR) for generating a synthesis gas, subjecting the synthesis gas to water gas shift conversion in a shift section for enriching the synthesis gas in hydrogen, subjecting the shifted gas to a carbon dioxide removal step whereby a CO₂-rich stream is produced as well as a H₂-rich stream and also a high-pressure flash gas stream, and where at least a portion of the H₂-rich stream is used as low carbon hydrogen fuel for at least the one or more fired heaters. The high-pressure flash gas stream is thereby advantageously integrated into the plant and process, for instance by combining it with the H₂-rich stream. The plant and process thus enable the provision of this low carbon hydrogen fuel and the utilization of high-pressure flash gas for the provision of a carbon-free or low-carbon substitute to hydrocarbon gases, such as natural gas, as fuel gas in the plant and/or process.

### BACKGROUND

In the production of hydrogen, a typical process comprises the steam reforming of natural gas for forming a syngas (synthesis gas), water gas shift of the syngas to increase the hydrogen content, CO₂-removal from the syngas and finally a hydrogen purification in usually a Pressure Swing Adsorption unit (PSA unit) thereby forming a hydrogen product and a PSA-off gas.

In this context of hydrogen production, most of the hydrogen today is used as feed in the production of e.g. ammonia or in refineries as part of the hydroprocessing stages used therein.

Other hydrocarbon gases such as biogas, this containing mostly methane, and which is produced by the fermentation of organic matter, is often targeted as a fuel substitute of natural gas.

US2013/0127163 A1 describes a process and plant (system) for generating and using decarbonized fuel for power generation. The plant comprises a syngas generation unit (2) using steam (3) from steam generation unit (24), water gas shift unit (6), acid gas removal unit (7) for removing a carbon dioxide off-gas stream (8) and decarbonized fuel stream (11). The latter stream is split into a first decarbonized fuel stream (12) for use in gas turbine generator unit (13) and a second decarbonized fuel stream 23 for use in the steam generation unit (24). An optional fuel stream (34) from the acid gas removal (7) could also be provided to the steam generation unit (24).

US2020055738 A1 describes a process and plant for the synthesis of ammonia from natural gas feed, the plant comprising a prereformer (PRE), autothermal reformer (ATR), shift section (SHF), CO₂ removal section (CDR) in an amine wash unit for producing a CO₂-rich stream and a H₂-rich stream, optional methanator (MET), ammonia synthesis section (SYN), hydrogen recovery section (HRU), a fired heater (AUX) for preheating of the natural gas feed and using part of the H₂-rich stream as fuel.

It would be desirable to provide a simple and more inexpensive process and plant for transforming a hydrocarbon gas as energy carrier and thereby as fuel, into a low carbon fuel.

It would be desirable to use a substantial part of the hydrogen provided from a hydrogen producing plant as a carbon-free fuel for use in the plant, instead of using a hydrocarbon gas such as natural gas as the fuel.

It would be desirable to reduce the CO₂ emissions connected with the use as fuel of hydrocarbon gases such as natural gas.

It would also be desirable to save the costs of capturing carbon from a hydrocarbon gas, such as an industrial gas containing significant amounts of hydrocarbons, biogas, or natural gas.

### SUMMARY

Accordingly, in a first aspect, the invention provides a plant for producing a H₂-rich stream from a hydrocarbon feed, said plant comprising:
an autothermal reformer (ATR), said ATR being arranged to receive a hydrocarbon feed and convert it to a stream of syngas;
a shift section, said shift section comprising one or more water gas shift (WGS) units, said one or more WGS units arranged to receive a stream of syngas from the ATR and shift it in one or more WGS shift steps, thereby providing a shifted syngas stream;
a CO₂ removal section, arranged to receive the shifted syngas stream from said shift section and separate a CO₂-rich stream from said shifted syngas stream, thereby providing said H₂-rich stream and also a high-pressure flash gas stream;
one or more fired heaters, arranged to pre-heat said hydrocarbon feed prior to it being fed to the ATR;
wherein said plant is arranged to feed at least a part of said H₂-rich stream as hydrogen fuel for at least said one or more fired heaters;
wherein
said plant (100) is absent of a hydrogen purification unit such as a pressure swing adsorption (PSA) unit, a hydrogen membrane or a cryogenic separation unit; and
the CO₂-removal section (170) is an amine wash unit which comprises a CO₂-absorber and a CO₂-stripper as well as a high-pressure flash drum and low-pressure flash drum, thereby separating said CO₂-rich stream (10), said H₂-rich stream (8) and said high pressure flash gas stream (12), and the plant (100) is arranged to feed at least part of said high-pressure flash gas stream to a unit or a stream of the plant.

The unit of the plant is any unit of the plant as recited above, such as a fired heater, or amine wash unit. The stream of the plant is any stream provided by any of said units, such as the H₂-rich stream.

Accordingly, in an embodiment according to the first aspect of the invention,

a) the plant (100) is arranged to feed at least a part of said high-pressure flash gas stream (12) as fuel for said at least one fired heaters (135); and/or

b) the plant (100) is arranged to recycle at least part of said high-pressure flash gas stream (12) to said CO₂-absorber of the amine wash unit, i.e. as an internal high-pressure (HP) flash gas recycle stream; and/or

c) the plant is arranged to mix at least part of said high-pressure flash gas stream (12) with said H₂-rich stream (8).

Thereby it is possible, in a simple manner, to decarbonize the hydrocarbon feed whereby at least 95% of the carbon is captured, while still achieving a high hydrogen purity in the H₂-rich stream.

The high-pressure flash gas stream is thereby advantageously integrated into the plant and process for further improving carbon capture.

Also provided, in a second aspect of the invention, as recited farther below, is a process for producing a H₂-rich stream from a hydrocarbon feed, using the plant as defined herein.

Further details of the invention are set out in the following description, following figure, aspects and the dependent claims.

As used herein, the term “syngas” means synthesis gas, which is a fuel gas mixture rich in carbon monoxide and hydrogen. Syngas normally contains also some carbon dioxide.

As used herein, the term CO₂-rich stream means a stream containing 95 vol. % or more, for instance 99.5 vol. % or 99.8 vol. % carbon dioxide.

As used herein, the term H₂-rich stream means a stream containing 95 vol. % or more, for instance 98 vol. % or more hydrogen, i.e. having a hydrogen purity of above 95 vol. %, with the balance being minor amounts of carbon containing compounds CH₄, CO, CO₂, as well as inerts N₂, Ar.

As used herein, the term “hydrogen fuel” is interchangeable with the term “low carbon hydrogen fuel” and means the part of the H₂-rich stream which is used as fuel and having a minor content of carbon containing compounds, as recited above.

As used herein, the term “at least a part of said H₂-rich stream” means that the H₂-rich stream from the CO₂ removal section may be diverted into separate H₂-rich streams, for instance also as H₂-recycle stream.

As used herein, the term “for at least said one or more fired heaters” means that the hydrogen fuel may also be used for providing energy in other units, such as any units where natural gas is normally used, for instance auxiliary boilers. It would be understood that the hydrogen fuel is not only for fired heaters. The hydrogen fuel can also be used as a hydrogen product based on requirement. The hydrogen fuel can be used in a number of applications where natural gas would have been used, e.g. mixing this hydrogen fuel in existing natural gas grid used for household use, or for transport fuel or in a cracker unit or in furnaces.

As used herein, the term “high pressure flash gas stream” means a stream derived from the CO₂ removal section having a pressure significantly above atmospheric pressure, such as 3-10 barg and having a significant content of hydrogen, such as 20-40 vol. % as well as a significant CO₂ content, such as 60-80 vol. %.

In an embodiment according to the first aspect of the invention, the hydrocarbon feed is selected from: natural gas, naphtha, LPG, biogas, industrial gas, or combinations thereof.

As used herein, the term “hydrocarbon feed” means a gas stream comprising hydrocarbons, in which the hydrocarbons may be as simple as e.g. methane CH₄ and may also comprise more complex molecules.

As used herein, the term “natural gas” means a mixture of hydrocarbons having methane as the major constituent. The methane content can be 85 vol % or higher, and other higher hydrocarbons (C₂+) may also be present such as ethane and propane.

As used herein, the term “naphtha” means a mixture of hydrocarbons in the range of C₅-C₁₀, preferably as paraffins and olefins. More specifically, the naphtha fraction contains hydrocarbons in the C₅-C₁₀ range i.e. with IBP=30° C., 50% BP=115° C. and FBP =160° C. according to characterization by ASTM D86.

As used herein, the term “LPG” means liquified petroleum gas or liquid petroleum gas and is a gas mixture of hydrocarbons comprising predominantly propane and butane.

As used herein, the term “biogas” means a gas produced by the fermentation of organic matter, consisting mainly of methane and carbon dioxide. The methane content can be in the range 40-70 vol. % and the carbon dioxide content in the range 30-60 vol %.

As used herein, the term “industrial gas” means a hydrocarbon containing off-gas having a heating value which is sufficient for burning the gas. An example is refinery off-gas, which often comprises components such as diolefins, olefins, CO₂, CO, hydrocarbons, H₂S, and various organic sulfur species.

In an embodiment according to the first aspect of the invention, the plant is arranged to divert the H₂-rich stream into: i) said H₂-rich stream as hydrogen fuel for at least said one or more fired heaters, ii) a H₂-product stream, and iii) a H₂-recycle stream. The H₂-product stream may represent 90 vol. % or more of said H₂-rich stream. The portion used as H₂-recycle may also be less than 1 vol. %.

In an embodiment according to the first aspect of the invention, the hydrogen fuel for the at least one fired heater is preferably used together with a separate fuel gas such as natural gas as well as combustion air. The necessary heat is thus generated by burning a mixture of these gases. The use of the hydrogen fuel reduces the amount of natural gas otherwise needed as fuel gas. A fired heater, apart from preheating the hydrocarbon feed gas fed to the ATR or to an optional prereformer, may also be used for example for superheating steam.

In an embodiment according to the first aspect of the invention, the plant is without i.e. is absent of, a steam methane reformer unit (SMR) upstream the ATR. Hence the plant is absent of a primary reforming unit and thus there is no primary reforming. For instance, the plant is absent of a convection reforming unit such as a gas heated reforming unit. Accordingly, the reforming section of the plant comprises an ATR and optionally also a pre-reforming unit, yet there is no steam methane reforming (SMR) unit, i.e. the use of e.g. a conventional SMR (also normally referred as radiant furnace, or tubular reformer) is omitted. Thereby, a reduction in plant size is also achieved. Other associated technical advantages are recited farther below.

The plant is absent hydrogen purification unit such as a pressure swing adsorption (PSA) unit, a hydrogen membrane or a cryogenic separation unit, i.e. the plant is absent of a dedicated hydrogen purification unit such as a pressure swing adsorption (PSA) unit, a hydrogen membrane or a cryogenic separation unit, which is normally required for the further purification of the H₂-rich stream from the CO₂ removal section. Thereby, a further reduction in plant size and thereby reduction in capital expenditure (CapEx) is achieved. Other associated technical advantages are also recited farther below.

In an embodiment according to the first aspect of the invention, the shifted gas stream, suitably after removing its water content as a process condensate, enters the CO₂-removal section by being introduced to the CO₂-absorber. Suitably also, in b) the internal HP flash gas recycle stream is combined with the shifted gas stream prior to being introduced to the CO₂-absorber.

By the invention, embodiments a), b), and c) may be combined. For instance, part of the high-pressure flash gas stream is recycled as fuel for the one or more fired heaters, while another part of the high-pressure flash gas stream is recycled to the CO₂-absorber of the amine washing unit i.e. as the internal HP flash gas recycle stream, and still another part of the high-pressure flash gas stream is mixed with the H₂-rich stream.

In an embodiment according to the first aspect of the invention, the plant is arranged to combine a) and c) by having arranged therein a mixing point, e.g. a mixing unit, for mixing at least part of the H₂-rich stream (8) as hydrogen fuel, with said high-pressure flash gas stream (12) upstream said one or more fired heaters (135). Thereby, a higher integration and thereby higher energy efficiency of the plant and process is achieved.

Instead of recycling or mixing only a part of the high-pressure flash gas stream as recited above, it may also be advantageous to recycle or mix the entire high-pressure flash gas stream.

Accordingly, in an embodiment according to the first aspect of the invention, in a) the plant is arranged to recycle the entire high-pressure flash gas stream as fuel for said at least one fire heaters; or

in b) the plant is arranged to recycle the entire high-pressure flash gas stream to said CO₂-absorber; or

in c) the plant is arranged to mix the entire high-pressure flash gas stream with said H₂-rich stream.

For instance, in b) the plant is arranged to recycle at least part of said high-pressure flash gas stream to said CO₂-absorber e.g. via a compressor. Thereby an even higher carbon capture is achieved, for instance from 95% without recycle to 97% or higher when e.g. recycling the entire (total) high-pressure flash gas. While such partial high-pressure flash gas stream recycle may result in an apparent slightly lower carbon recovery, total high-pressure flash gas recycle by returning the entire stream to the CO₂-absorber-, provides both the benefits of maintaining high CO₂ purity as well as a high carbon recovery.

For instance, in c) the hydrogen amount present in the high-pressure flash gas stream is added to the H₂-rich stream making the plant efficient for the same amount of production of H₂ moles. While this may result in an apparent slightly lower purity of the H₂-rich stream, this is a cost-effective way of utilizing the high-pressure flash gas stream without having the need to recycle at least part of it via e.g. a compressor to the CO₂-absorber or having the need to burn at least a part of it in the fired heater resulting in potential higher CO₂ emissions. Mixing the entire high-pressure flash gas stream to said H₂-rich stream further increases the plant efficiency and reduces the cost by maintaining the same CO₂ purity.

By the term “plant efficiency” is meant energy efficiency, which corresponds to energy consumption in terms of the natural gas used in the process (or plant). Thus, increase in plant efficiency means reduction in natural gas consumption.

In an embodiment according to the first aspect of the invention, said plant is arranged to provide an inlet temperature of said hydrocarbon feed to the ATR of below 600° C., such as 550° C. or 500° C. or lower, for instance 300-400° C. The above temperatures are lower than the typical ATR inlet temperatures of 600-700° C. and which are normally desirable to reduce oxygen consumption in the ATR. Hence, the plant may purposely and counterintuitively also be arranged for having a lower ATR inlet temperature. By having a lower ATR inlet temperature, suitably 550° C. or lower, such as 500° C. or lower, e.g. 300-400° C., the amount of heat required in a heater unit for preheating the hydrocarbon, e.g. a fired heater, is significantly reduced, thereby enabling a much smaller fired heater, or reducing the number of fired heaters and thereby further reducing CO₂-emissions i.e. reducing the carbon footprint of the plant. Suitably, the plant is arranged accordingly without the use of a primary reforming unit such as an SMR.

In an embodiment according to the first aspect of the invention, the plant is arranged for adding steam to: the hydrocarbon feed, the ATR, and/or to the shift section.

In an embodiment according to the first aspect of the invention, the plant is arranged to provide a steam-to-carbon ratio in the ATR of 2.6-0.1, 2.4-0.1, 2-0.2, 1.5-0.3, 1.4-0.4, such as 1.2, 1.0 or 0.6. Preferably also, the ATR is arranged to operate at 20-60 barg, such as 30-40 barg.

In a particular embodiment, the plant is arranged to provide a steam-to-carbon ratio in the ATR of 0.4 or higher, such as 0.6 or higher, such as 0.8 or higher, such as 0.9, 1.0 or higher, for instance in the range 1.0-2.0, e.g. 1.1, 1.3, 1.5, or 1.7, yet said steam-to-carbon ratio being below 2.0. Preferably also, the ATR is arranged to operate at 20-30 barg, such as 24-28 barg. These steam-to-carbon ratios are higher than what normally would be expected to be used for ATR operation, which typically are in the range 0.3-0.6. Also, the pressures are lower than what normally would be expected for ATR operation which typically are 30 barg or higher, for instance 30-40 barg.

Operating the plant at the low steam-to-carbon ratio of e.g. 0.4 or 0.6 in the ATR enables lower energy consumption and reduced equipment size as less steam/water is carried over in the plant.

As used herein the term “steam-to-carbon ratio in the ATR” means steam-to-carbon molar ratio, which is defined by the molar ratio of all steam added to the hydrocarbon feed and the ATR, i.e. excluding any steam added to the shift section downstream, to all the carbon in hydrocarbons in the feed gas (hydrocarbon feed), which is optionally prereformed, and reformed in the ATR.

More specifically, the steam/carbon ratio is defined as the ratio of all steam added to the reforming section upstream the shift section e.g. the high temperature shift section, i.e. steam which may have been added to the reforming section via the feed gas, oxygen feed, by addition to the ATR and the carbon in hydrocarbons in the feed gas (hydrocarbon feed) to the reforming section on a molar basis. The steam added includes only the steam added to the ATR and upstream the ATR.

As used herein the term “syngas from the ATR” means syngas at the exit of the ATR and to which no steam has been added e.g. any additional steam used for the downstream shift section. It would therefore be understood that said steam to carbon ratio in the ATR is the steam/carbon ratio on molar basis in the reforming section. The reforming section includes the ATR and any prereformer, but not the shift section.

In an embodiment according to the first aspect of the invention, the steam/carbon ratio in the shift section, including steam added to the shift section, is 0.9-3.0 such as 0.9-2.6, for instance 1.0, 1.2, 1.4, 1.6, 1.8, 2.0, 2.2 or 2.4.

As used herein, the term “steam-to-carbon ratio in the shift section” means after adding optional steam to the syngas stream prior to entering the shift section and/or within the shift section, for instance in between a HTS unit and LTS unit.

In an embodiment according to the first aspect of the invention, the at least one or more WGS units comprise: a high temperature shift unit (HTS-unit); and a medium temperature shift (MTS-unit) and/or a low temperature shift unit (LTS-unit, 150). Thus, in a particular embodiment, the plant comprises a HTS-unit and a downstream MTS-unit. In another particular embodiment, the plant comprises a HTS-unit and a downstream LTS-unit. In yet another particular embodiment, the plant comprises a HTS-unit and a downstream MTS and LTS-unit. Water gas shift enables the enrichment of the syngas in hydrogen, as is well-known in the art.

In another particular embodiment, the HTS-unit comprises a promoted zinc-aluminium oxide based high temperature shift catalyst, preferably arranged within said HTS unit in the form of one or more catalyst beds, and preferably the promoted zinc-aluminium oxide based HT shift catalyst comprises in its active form a Zn/AI molar ratio in the range 0.5 to 1.0 and a content of alkali metal in the range 0.4 to 8.0 wt % and a copper content in the range 0-10% based on the weight of oxidized catalyst. In particular, the zinc-aluminum oxide based catalyst in its active form may comprise a mixture of zinc aluminum spinel and zinc oxide in combination with an alkali metal selected from the group consisting of Na, K, Rb, Cs and mixtures thereof, and optionally in combination with Cu. The catalyst, as recited above, may have a Zn/AI molar ratio in the range 0.5 to 1.0, a content of alkali metal in the range 0.4 to 8.0 wt % and a copper content in the range 0-10% based on the weight of oxidized catalyst, as for instance disclosed in applicant's US2019/0039886 A1.

In a conventional hydrogen plant the standard use of iron based high temperature shift catalyst requires a steam/carbon ratio of around 3.0 to avoid iron carbide formation, since iron carbide will weaken the catalyst pellets and may result in catalyst disintegration and pressure drop increase. Iron carbide will also catalyse the production of hydrocarbons as byproducts by Fischer-Tropsch reactions, which consume hydrogen, whereby the efficiency of the shift section is reduced.

By using a non Fe-catalyst, such as a promoted zinc-aluminum oxide based catalyst, for example, the Topsoe SK-501 Flex™ as the HTS catalyst, operation of the ATR and HTS at a low steam/carbon ratio (steam-to-carbon molar ratio), is possible. Accordingly, this HTS catalyst is not limited by strict requirements to steam to carbon ratios, which makes it possible to reduce steam/carbon ratio in the shift section as well as in the ATR i.e. reforming section. Thereby a higher flexibility in plant operation is achieved.

The provision of additional WGS units or steps, namely MTS and/or LTS, adds further flexibility to the plant and/or process when operating at low steam/carbon ratios, such as 0.9 in the syngas including steam added to the shift section. The low steam/carbon ratio may result in a lower than optimal shift conversion which means that in some embodiments it may be advantageous to provide one or more additional shift steps. Generally speaking, the more converted CO in the shift steps the more gained H₂ and the smaller reforming section required.

This is also seen from the exothermic shift reaction: CO+H₂O↔CO₂+H₂+heat

Preferably steam is added upstream the HTS unit. Steam may optionally be added after the high temperature shift step such as before one or more following MT or LT shift and/or HT shift steps in order to maximize the performance of said following HT, MT and/or LT shift steps.

Having two or more HTS steps in series, such as a HTS step comprising two or more shift reactors in series e.g. with the possibility for cooling and/or steam addition in between, may be advantageous as it may provide increased shift conversion at high temperature which gives a possible reduction in required shift catalyst volume and therefore a possible reduction in CapEx. Furthermore, high temperature reduces the formation of methanol, a typical byproduct of water gas shifting.

Preferably the MT and LT shift steps are carried out over promoted copper/zinc/alumina catalysts. For example, the low temperature shift catalyst type may be LK-821-2, which is characterized by high activity, high strength, and high tolerance towards sulphur poisoning. A top layer of a special catalyst may be installed to catch possible chlorine in the gas and to prevent liquid droplets from reaching the shift catalyst.

The MT shift step may be carried out at temperatures at 190-360° C. The LT shift step may be carried out at temperatures at T_{dew}+15-290° C., such as, 200-280° C. For example, the low temperature shift inlet temperature is from T_{dew}+15-250° C., such as 190-210° C.

Reducing the steam/carbon ratio leads to reduced dew point (T_{dew}) of the gas being processed, which means that the inlet temperature to the MT and/or LT shift steps can be lowered. A lower inlet temperature means lower CO slippage outlet the shift reactors, which is also advantageous for the plant and/or process.

In another embodiment according to the first aspect of the invention, the plant comprises a steam superheater which is arranged for being heated by shifted syngas preferably downstream the high temperature shift unit. This further reduces the additional firing of make-up fuel e.g. natural gas and hydrogen fuel in the fired heater and improves thereby the carbon recovery and lower emissions.

It is well known that MT/LT shift catalysts are prone to produce methanol as byproduct. Such byproduct formation can be reduced by increasing steam/carbon. The CO₂ wash which may be a part of the CO₂ removal section subsequent to the MT/LT shifts, requires heat for regeneration of the CO₂ absorption solution. This heat is normally provided as sensible heat from the gas being processed, i.e. the shifted syngas, but this is not always enough. Typically, an additionally steam fired reboiler is providing the makeup duty. Optionally adding steam to the gas can replace this additionally steam fired reboiler and simultaneously ensures reduction of byproduct formation in the MT/LT shift section.

It is therefore also envisaged that the plant further comprises a methanol removal section arranged between the shift section and said CO₂ removal section, said methanol removal section being arranged to separate a methanol-rich stream from said shifted syngas stream. The methanol formed by the MT/LT shift catalyst can optionally be removed from the synthesis gas in a water wash to be placed upstream the CO₂ removal section or in the CO₂ product stream.

By the invention, the reforming section comprises an ATR and optionally also a pre-reforming unit, yet preferably there is no steam methane reforming (SMR) unit, i.e. the use of a conventional SMR, also normally referred as radiant furnace, or tubular reformer, or another primary reforming unit, is omitted.

SMR-based plants typically operate with a steam-to-carbon ratio of about 3. While omitting the use of SMR would convey significant advantages in terms of energy consumption and plant size, since the ATR enables operation at steam to carbon molar ratios well below 1 and thereby significantly reduce the amount of steam carried in the plant/process, a hydrogen purification unit such as a Pressure Swing Adsorption (PSA) unit would normally be needed to enrich the content of hydrogen from a CO₂-depleted syngas stream obtained after the CO₂-removal. The CO₂-depleted syngas would therefore normally contain around 500 ppmv of CO₂ or lower, for instance down to 20 ppmv CO₂, and about 90 vol. % H₂. The hydrogen concentration is relatively low and hence, further purification is required to obtain hydrogen purity levels acceptable for end users, such as 98% vol. % H₂ or higher.

The present invention omits the use of a hydrogen purification unit, yet still enables the production of a H₂-rich stream from the CO₂-removal section of a purity higher than 95 vol. %, e.g. 98 vol. % or higher, thus a significantly higher purity than the above 90 vol. %, and also a CO₂-rich stream of a purity higher than 95 vol. %, e.g. 99 vol. % or higher, such as 99.5 vol. % or 99.8 vol. %. In particular, the lower the pressure in the ATR, the higher the steam-to-carbon ratio in the syngas withdrawn from the ATR and optionally also in the syngas including steam added to the shift section, the higher the purity of the H₂-rich stream from the CO₂ removal section.

Hence, the invention enables also in a simple manner the production of a hydrogen rich stream which for the most part can be used as hydrogen product having a hydrogen purity acceptable for end users, such as refineries, and where part of the hydrogen rich stream can also be diverted as a low carbon hydrogen fuel for use in the plant instead of the typical use of natural gas, thereby reducing CO₂-emissions. The reduced CO₂-emissions are also obtained at a lower cost than by e.g. capturing carbon from an industrial gas such as a refinery off-gas. In other words, capturing carbon from production of the H₂-rich stream is also more economic than capturing carbon directly from the flue gas generated from the burning of the industrial gas.

In addition, the flue gas from a fired heater would normally be emitted at low pressure, thus the energy and capital cost for CO₂-removal from the low-pressure flue gas is high. For instance, in an amine wash CO₂ removal unit the energy requirement for compressing the flue gas and energy required for regenerating the CO₂ is significantly higher which otherwise would be lesser if CO₂ is recovered from the shifted syngas.

Moreover, additional unit operations are needed to cool and purify the flue gas which increases the capital expenses. The impurities in flue gas typically are SOₓ, and NOₓ, not suitable in an amine wash type CO₂ removal unit. Thus, the present invention removes CO₂ from the process gas itself.

As used herein, the term “flue gas” means a gas obtained from burning hydrocarbon streams and/or hydrogen, the flue gas containing mainly CO₂, N₂ and H₂O with traces of CO, Ar and other impurities, plus a little surplus of O₂.

The separated CO₂-rich stream according to the present invention may be disposed by e.g. sequestration in geological structures or used as industrial gas for various purposes.

In an embodiment according to the first aspect of the invention, the plant further comprises one or more prereformer units arranged upstream the ATR, said one or more prereformer units being arranged to pre-reform said hydrocarbon feed prior to it being fed to the ATR. In a particular embodiment, the plant comprises two or more adiabatic prereformers arranged in series with interstage preheater(s) i.e. in between prereformer preheater(s). In the prereforming unit(s) all higher hydrocarbons can be converted to carbon oxides and methane, but the prereforming unit(s) are also advantageous for light hydrocarbons. Providing the prereforming unit(s), hence prereforming step(s), may have several advantages including reducing the required O₂ consumption in the ATR and allowing higher inlet temperatures to the ATR since cracking risk by preheating is minimized. Furthermore, the prereforming unit(s) may provide an efficient sulphur guard resulting in a practically sulphur free feed gas entering the ATR and the downstream system. The prereforming step(s) may be carried out at temperatures between 300-650° C., preferably 390-480° C.

As used herein, the terms “prereformer”, “prereformer unit” and “prereforming unit”, are used interchangeably.

In another embodiment, the plant is absent of a prereformer unit. Plant size and attendant costs are thereby reduced.

In an embodiment according to the first aspect of the invention, said plant further comprises a hydrogenator unit and a sulfur absorption unit which are arranged upstream said at one or more pre-reformer units or upstream said ATR, and said plant is arranged for mixing a portion of the H₂-rich stream with the hydrocarbon feed before being fed to the feed side of the hydrogenator unit. In other words, the plant is arranged for mixing a portion of the H₂-rich stream, i.e. as a hydrogen-recycle, with hydrocarbon feed upstream the hydrogenator unit preferably by providing a hydrogen-recycle compressor. Thereby, sulfur in the hydrocarbon feed which is detrimental for downstream catalysts is removed while at the same time the energy consumption is further reduced, as hydrogen produced in the process is used in the main hydrocarbon feed prior to it entering the hydrogenator instead of using external hydrogen sources.

As used herein, the term “feed side” means inlet side or simply inlet. For instance, the feed side of the hydrogenator unit means the inlet side of the hydrogenator unit.

It would also be understood that the reforming section is the section of the plant comprising units up to and including the ATR, i.e. the ATR, or the one or more pre-reformer units and the ATR, or the hydrogenator and sulfur absorber and the one or more prereformer units and ATR.

In another embodiment according to the first aspect of the invention, the plant comprises also an air separation unit (ASU) which is arranged for receiving an air stream and produce an oxygen comprising stream which is then fed through a conduit to the ATR. Preferably, the oxygen comprising stream contains steam added to the ATR in accordance with the above-mentioned embodiment. Examples of oxidant comprising stream are: oxygen, mixture of oxygen and steam, mixtures of oxygen, steam, and argon, and oxygen enriched air.

The temperature of the synthesis gas at the exit of the ATR is between 900 and 1100° C., or 950 and 1100° C., typically between 1000 and 1075° C. This hot effluent synthesis gas which is withdrawn from the ATR (syngas from the ATR) comprises carbon monoxide, hydrogen, carbon dioxide, steam, residual methane, and various other components including nitrogen and argon.

Autothermal reforming (ATR) is described widely in the art and open literature. Typically, the ATR comprises a burner, a combustion chamber, and catalyst arranged in a fixed bed all of which are contained in a refractory lined pressure shell. ATR is for example described in Chapter 4 in “Studies in Surface Science and Catalysis”, Vol. 152 (2004) edited by Andre Steynberg and Mark Dry, and an overview is also presented in “Tubular reforming and autothermal reforming of natural gas—an overview of available processes”, lb Dybkjaer, Fuel Processing Technology 42 (1995) 85-107.

The plant preferably comprises also conduits for the addition of steam to the hydrocarbon feed, to the oxygen comprising stream and to the ATR, and optionally also to the inlet of the reforming section e.g. to the hydrocarbon feed, and also to the inlet of the shift section in particular to the HTS unit, and/or to additional shift units downstream the HTS unit.

The CO₂-removal section is an amine wash unit and comprises a CO₂-absorber and a CO₂-stripper as well as a high-pressure flash drum and low-pressure flash drum, thereby separating a CO₂-rich stream containing more than 99 vol. % CO₂ such as 99.5 vol. % CO₂ or 99.8 vol. % CO₂, a H₂-rich stream containing 98 vol. % hydrogen, as well as a high pressure flash gas containing about 60 vol. % CO₂ and 40 vol. % H₂. In the amine wash unit, in the first high pressure flash step via said high-pressure drum, the bulk part of the impurities is released together with some CO₂ to the gas phase as a high-pressure flash gas. In the low-pressure flash step via said low-pressure flash drum, mainly CO₂ is released to a final product as a CO₂-rich stream. The CO₂ from the CO₂ removal section, i.e. the CO₂-rich stream, is as recited farther above, is preferably captured and transported for e.g. sequestration in geological structures, thereby reducing the CO₂ emission to the atmosphere.

In a second aspect of the invention, there is also provided a process for producing a H₂-rich stream from a hydrocarbon feed, said process comprising the steps of:
providing a plant according to the first aspect of the invention;
supplying a hydrocarbon feed to the ATR, and converting it to a stream of syngas;
withdrawing a stream of syngas from the ATR and supplying it to the shift section shifting the syngas in a HTS-step and optionally also in a MTS and/or LTS-shift step, thereby providing a shifted syngas stream;
supplying the shifted gas stream from the shift section to the CO₂ removal section, said CO₂-removal section being an amine wash unit which comprises a

CO₂-absorber and a CO₂-stripper as well as a high-pressure flash drum and low-pressure flash drum, and separating a CO₂-rich stream from said shifted syngas stream, thereby providing a H₂-rich stream and also a high-pressure flash gas stream;
omitting feeding at least a part of said H₂-rich stream (8) to a hydrogen purification unit such as a pressure swing adsorption (PSA) unit, a hydrogen membrane or a cryogenic separation unit;
feeding at least a part of said H₂-rich stream as hydrogen fuel to the at least one or more fired heaters;
the process further comprising:
a) feeding at least a part of said high-pressure flash gas stream (12) as fuel to said one or more fired heaters (135); and/or
b) recycling at least part of said high-pressure flash gas stream (12) to said CO₂-absorber i.e. as internal high-pressure (HP) flash gas recycle stream; and/or
c) mixing at least part of said high-pressure flash gas stream (12) with said H₂ rich stream (8).

It would be understood that the use of the article “a” in a given item, refer to the same item in the first aspect of the invention. For instance, the term “a H₂-rich stream” refers to the H₂-rich stream in accordance with the first aspect of the invention.

In an embodiment according to the second aspect of the invention, the shifted gas stream, suitably after removing its water content as a process condensate, enters the CO₂-removal section by being introduced to the CO₂-absorber. Suitably also, the internal HP flash gas recycle stream is combined with the shifted gas stream prior to being introduced to the CO₂-absorber.

As in connection with the first aspect of the invention, the embodiments of the invention according to the second aspect as recited above may be combined. For instance, part of the high-pressure flash gas stream is recycled as fuel for the one or more fired heaters, while another part of the high-pressure flash gas stream is recycled to the CO₂-absorber of the amine washing unit i.e. as the internal HP recycle stream, and still another part of the high-pressure flash gas stream is mixed with the H₂-rich stream.

In an embodiment, the process comprises mixing said part of the H₂-rich stream (8) as hydrogen fuel, with said high-pressure flash gas stream (12) upstream said one or more fired heaters (135). For instance, the high-pressure flash gas stream (12) is mixed with the H₂-rich stream (8) prior to feeding to the one or more fired heaters (135).

Also, instead of recycling or mixing only a part of the high-pressure flash gas stream as recited above, it may also be advantageous to recycle or mix the entire high-pressure flash gas stream.

Accordingly, in an embodiment according to the second aspect of the invention, the process comprises:

recycling the entire high-pressure flash gas stream as fuel for said at least one fire heaters; or

recycling the entire high-pressure flash gas stream to said CO₂-absorber; or

mixing the entire high-pressure flash gas stream with said H₂-rich stream.

In an embodiment according to the second aspect of the invention, the process further comprises adding steam to: the ATR, the hydrocarbon feed, and/or the syngas stream prior to entering the shift section.

In an embodiment according to the second aspect of the invention, the steam-to-carbon ratio in the ATR is 2.6-0.1, 2.4-0.1, 2-0.2, 1.5-0.3, 1.4-0.4, such as 1.2, 1.0 or 0.6. Preferably also, the pressure in the ATR is 20-60 barg, such as 30-40 barg.

In a particular embodiment, the steam-to-carbon ratio of the syngas gas in the ATR is 0.4 or higher, such as 0.6 or higher, such as 0.8 or higher, yet said steam-to-carbon ratio being not greater than 2.0, such as 1.0 or higher, for instance in the range 1.0-2.0, e.g. 1.1, 1.3, 1.5, or 1.7; and the pressure in the ATR is is 20-30 barg, such as 24-28 barg.

In an embodiment according to the second aspect of the invention, the steam/carbon ratio in the shift section including steam added to the shift section, is 0.9-3.0 such as 0.9-2.6, for instance 1.0, 1.2, 1.4, 1.6, 1.8, 2.0, 2.2 or 2.4.

The carbon feed for the ATR is mixed with oxygen and additional steam in the ATR, and a combination of at least two types of reactions take place. These two reactions are combustion and steam reforming.

Combustion zone:

2H₂+O₂↔2H₂O heat (3)

CH₄+3/2 O₂↔CO+2H₂O+heat (4)

Thermal and catalytic zone:

CH₄+H₂O+heat↔CO+3H₂ (5)

CO+H₂O↔CO₂+H₂ +heat (6)

The combustion of methane to carbon monoxide and water (reaction (4)) is a highly exothermic process. Excess methane may be present at the combustion zone exit after all oxygen has been converted.

The thermal zone is part of the combustion chamber where further conversion of the hydrocarbons proceeds by homogenous gas phase reactions, mostly reactions (5) and (6). The endothermic steam reforming of methane (5) consumes a large part of the heat developed in the combustion zone.

Following the combustion chamber there may be a fixed catalyst bed, the catalytic zone, in which the final hydrocarbon conversion takes place through heterogeneous catalytic reactions. At the exit of the catalytic zone, the synthesis gas preferably is close to equilibrium with respect to reactions (5) and (6).

In an embodiment, the process operates with no additional steam addition between the reforming step(s) and the high temperature shift step.

In another embodiment according to the second aspect of the invention, the space velocity in the ATR is low, such as less than 20000 Nm³ C/m³/h, preferably less than 12000 Nm³ C/m³/h and most preferably less 7000 Nm³ C/m³/h. The space velocity is defined as the volumetric carbon flow per catalyst volume and is thus independent of the conversion in the catalyst zone.

In an embodiment according to the second aspect of the invention, the process comprises pre-reforming said hydrocarbon feed in one or more prereformer units prior to it being fed to the ATR.

In another embodiment, there is no prereforming step.

In an embodiment according to the second aspect of the invention, the process further comprises providing a hydrogenator unit and a sulfur absorption unit for conditioning the hydrocarbon feed, e.g. for sulfur removal, prior to said prereforming or prior to passing to said ATR, and mixing a portion of the H₂-rich stream, i.e. as H₂-recycle, with the hydrocarbon feed before being fed to the feed side of the hydrogenator unit.

It would be understood that any of the embodiments and associated benefits of the first aspect of the invention may be used in connection with any of the embodiments of the second aspect of the invention, and vice versa.

### BRIEF DESCRIPTION OF THE FIGURES

FIG. 1 illustrates a layout of an ATR-based hydrogen process and plant.

FIG. 2 illustrates a layout of the ATR-based hydrogen process and plant of FIG. 1 with integration of high-pressure flash gas stream from CO₂-removal section into the process, in accordance with embodiments of the invention.

### DETAILED DESCRIPTION

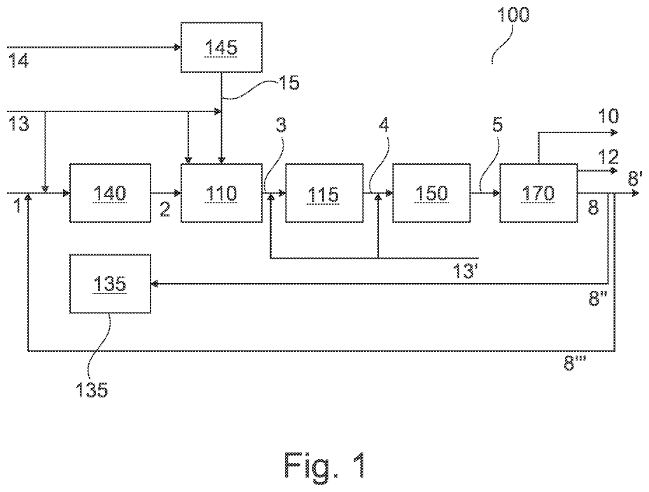

With reference to FIG. 1, there is shown a plant/process 100 in which a hydrocarbon feed 1 such as natural gas is passed to a reforming section comprising a pre-reforming unit 140 and ATR 110. The reforming section may also include a hydrogenator and sulfur absorber unit (not shown) upstream the pre-reforming unit 140. Prior to entering the hydrogenator, the hydrocarbon steam 1 is mixed with a hydrogen-recycle stream 8′″diverted from a H₂-rich stream 8 produced in downstream CO₂-removal section 170. Prior to entering the pre-reforming unit 140, the hydrocarbon feed 1 is also mixed with steam 13 and the resulting prereformed hydrocarbon feed 2 is fed to the ATR 110, as so is an oxidant stream formed by mixing oxygen 15 and steam 13. Steam may also be added separately, as also shown in the figure. The oxygen stream 15 is produced by an air separation unit (ASU) 145 to which air 14 is fed. In the ATR 110, the hydrocarbon feed 2 is converted into a stream of syngas 3, which is withdrawn from the ATR 110 and passed to a shift section. The hydrocarbon feed 2 enters the ATR at 650° C. and the temperature of the oxygen is around 253° C. The steam/carbon ratio of the the ATR is preferably 0.4 or higher, such as 0.6 or higher, or such as 0.8 or higher, yet no greater than 2.0. Preferably also, the pressure in the ATR 110 is 24-28 barg. This syngas exits the ATR at about 1050° C. through a refractory lined outlet section and transfer line to waste heat boilers (not shown) in the syngas i.e. process gas cooling section.

5 The shift section comprises a high temperature shift (HTS) unit 115 where additional or extra steam 13′ also may be added upstream, thereby a steam-to-carbon ratio in the shift section of preferably about 1.0 or higher is used. Additional shift units, such as a low temperature shift (LTS) unit 150 may also be included in the shift section. Additional or extra steam may also be added downstream the HTS unit 115 yet upstream the LTS unit 150 for increasing the above steam-to-carbon ratio. From the shift section, a shifted gas stream 5 enriched in hydrogen is produced which is then fed to a CO₂-removal section 170. The CO₂-removal section 170 is suitably an amine wash unit which comprises a CO₂-absorber and a CO₂-stripper, which separates a CO₂-rich stream 10 containing more than 99 vol. % CO₂ and a H₂-rich stream 8 containing 98 vol. % hydrogen or higher. The CO₂-removal section 170 also generates a high-pressure flash gas stream 12. The plant 100 is absent of a hydrogen purification unit, such as a PSA.

The H₂-rich stream 8 is divided into a H₂-product 8′ for supplying to end customers such as refineries, a low carbon hydrogen fuel 8″ which is used in fired heater unit(s) 135, and a hydrogen-recycle 8— for mixing with the hydrocarbon feed 1. The fired heater 135 provides for the indirect heating of hydrocarbon feed 1 and hydrocarbon feed 2.

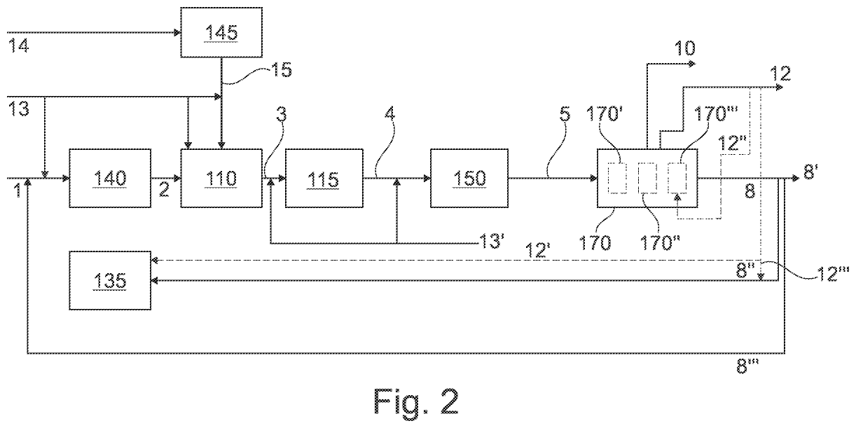

Now with reference to FIG. 2, embodiments integrating the use of the high-pressure flash gas stream 12, are shown. The CO₂-removal section 170 comprises a CO₂-stripper 170′, low and high-pressure drums 170″ and CO₂-absorber 170′″. In an embodiment, at least a part of said high-pressure flash gas stream 12 is fed as fuel 12′ to the fired heater 135. In another embodiment, at least part of the high-pressure (HP) flash gas stream 12 is recycled as stream 12″ to the CO₂-absorber 170′″, i.e. as an internal HP recycle stream. While the figures show the shifted gas stream 5 entering the CO₂-removal section 170 at one end thereof away from the CO₂-absorber 170″, it would be understood that the shifted gas stream 5, suitably after removing its water content as a process condensate, enters the CO₂-removal section 170 by being introduced to the CO₂-absorber 170′″. Suitably also, the internal HP recycle stream 12″ is combined with the shifted gas stream 5 prior to being introduced to the CO₂-absorber 170′″. In another embodiment, at least part of said high-pressure flash gas stream 12, as stream 12′″, is mixed with the H₂-rich stream 8, prior to feeding to the fired heater 135.

1. A plant for producing a H₂-rich stream from a hydrocarbon feed (1, 2), said plant comprising:
an autothermal reformer, said ATR being arranged to receive a hydrocarbon feed and convert it to a stream of syngas;
a shift section, said shift section comprising one or more water gas shift (WGS) units, said one or more WGS units arranged to receive the stream of syngas from the ATR and shift it in one or more WGS steps, thereby providing a shifted syngas stream;
a CO₂ removal section, arranged to receive the shifted syngas stream from said shift section and separate a CO₂-rich stream from said shifted syngas stream, thereby providing said H₂-rich stream and also a high-pressure flash gas stream;
one or more fired heaters, arranged to pre-heat said hydrocarbon feed (1 prior to it being fed to the ATR;
wherein said plant is arranged to feed at least a part of said H₂-rich stream as hydrogen fuel for at least said one or more fired heaters;
wherein
said plant is absent of a hydrogen purification unit such as a pressure swing adsorption (PSA) unit, a hydrogen membrane or a cryogenic separation unit; and
the CO₂-removal section is an amine wash unit which comprises a CO₂-absorber and a CO₂-stripper as well as a high-pressure flash drum and low-pressure flash drum, thereby separating said CO₂-rich stream, said H₂-rich stream and said high pressure flash gas stream; and
the plant is arranged to feed at least part of said high-pressure flash gas stream to a unit or a stream of the plant.

2. The plant according to claim 1, wherein p1 a) the plant is arranged to feed at least a part of said high-pressure flash gas stream as fuel for said at least one fired heaters; and/or
b) the plant is arranged to recycle at least part of said high-pressure flash gas stream to said CO₂-absorber of the amine wash unit; and/or
c) the plant is arranged to mix at least part of said high-pressure flash gas stream with said H₂-rich stream.

3. The plant according to claim 1, wherein
the plant is arranged to combine a) and c) by having arranged therein a mixing point for mixing at least part of the H₂-rich stream as hydrogen fuel, with said high-pressure flash gas stream upstream said one or more fired heaters.

4. The plant (100) according to claim 1, wherein:
in a) the plant is arranged to recycle the entire high-pressure flash gas stream as fuel for said at least one fire heaters; or
in b) the plant is arranged to recycle the entire high-pressure flash gas stream to said CO₂-absorber; or
in c) the plant is arranged to mix the entire high-pressure flash gas stream with said H₂-rich stream.

5. The plant according to claim 1, said plant being arranged to provide an inlet temperature of said hydrocarbon feed to the ATR of below 600° C.

6. The plant according to claim 1, wherein said plant is arranged to provide a steam-to-carbon ratio in the ATR of 2.6-0.1, and/or wherein the ATR is arranged to operate at 20-60 barg.

7. The plant according to claim 6, wherein said plant is arranged to provide a steam-to-carbon ratio in the ATR of 0.4 or higher, yet said steam-to-carbon ratio being not greater than 2.0, and/or wherein the ATR is arranged to operate at 20-30 barg.

8. The plant according to claim 1, wherein the at least one or more WGS units comprise: a high temperature shift unit (HTS-unit);
and a medium temperature shift (MTS-unit) and/or a low temperature shift unit (LTS-unit).

9. The plant according to claim 8, further comprising a steam superheater which is arranged for being heated by shifted syngas.

10. The plant according to claim 1, further comprising one or more prereformer units arranged upstream the ATR, said one or more prereformer units being arranged to pre-reform said hydrocarbon feed prior to it being fed to the ATR.

11. The plant according to claim 1, wherein said plant is absent of a prereformer unit.

12. The plant according to claim 1, said plant further comprising a hydrogenator unit and a sulfur absorption unit which are arranged upstream said one or more pre-reformer units or upstream said ATR, and said plant being arranged for mixing a portion of the H₂-rich stream with the hydrocarbon feed before being fed to the feed side of the hydrogenator unit.

13. A process for producing a H₂-rich stream from a hydrocarbon feed, said process comprising the steps of:
providing a plant according to claim 1;
supplying a hydrocarbon feed to the ATR, and converting it to a stream of syngas;
withdrawing a stream of syngas from the ATR and supplying it to the shift section, shifting the syngas in a HTS-step and optionally also in a MTS and/or LTS-shift step, thereby providing a shifted syngas stream;
supplying the shifted gas stream from the shift section to the CO₂ removal section, said CO₂-removal section being an amine wash unit which comprises a CO₂-absorber and a CO₂-stripper as well as a high-pressure flash drum and low-pressure flash drum, and separating a CO₂-rich stream from said shifted syngas stream, thereby providing a a H₂-rich stream and also a high-pressure flash gas stream;
omitting feeding at least a part of said H₂-rich stream to a hydrogen purification unit such as a pressure swing adsorption (PSA) unit, a hydrogen membrane or a cryogenic separation unit;
feeding at least a part of said H₂-rich stream as hydrogen fuel to the at least one or more fired heaters;
the process further comprising:
a) feeding at least a part of said high-pressure flash gas stream as fuel to said one or more fired heaters; and/or
b) recycling at least part of said high-pressure flash gas stream to said CO₂-absorber of the amine wash unit; and/or
c) mixing at least part of said high-pressure flash gas stream with said H₂ rich stream.

14. The process of claim 13, comprising: mixing said H₂-rich stream, with said high-pressure flash gas stream upstream said one or more fired heaters, suitably by mixing the high-pressure flash gas stream with the H₂-rich stream prior to feeding to the one or more fired heaters.

15. The process of claim 13, comprising:
recycling the entire high-pressure flash gas stream as fuel for said at least one fire heaters; or
recycling the entire high-pressure flash gas stream to said CO₂-absorber; or mixing the entire high-pressure flash gas stream with said H₂-rich stream.

16. The process of any of claim 13, wherein the steam-to-carbon ratio in the ATR is 2.6-0.1; and/or wherein the pressure in the ATR (110) is 20-60 barg.

17. The process of claim 16, wherein the steam-to-carbon ratio in the ATR is 0.4 or higher, yet said steam-to-carbon ratio being not greater than 2.0; and/or wherein the pressure in the ATR is is 20-30 barg.
